(19) United States
(12) Patent Application Publication
(10) Pub. No.: US 2012/0098811 A1
(43) Pub. Date: Apr. 26, 2012

(54) Display Device

(76) Inventor: Jung-Mok Park, Yongin-city (KR)

(21) Appl. No.: 13/082,251

(22) Filed: Apr. 7, 2011

(30) Foreign Application Priority Data
Oct. 25, 2010 (KR) 2010-0104038

(51) Int. Cl. G09G 5/00

(52) U.S. Cl. 345/211

(57) ABSTRACT

A display device includes a first substrate divided into a display area and a non-display area, a gate line insulated from a data line and crossing the data line in the display area on the first substrate, a second substrate facing the first substrate, a common electrode on the second substrate, a common power supply line at a same layer as the gate line in the non-display area on the first substrate and being extended in parallel to the data line, and a short circuit point extending in a direction toward an edge of the first substrate from the common power supply line and being electrically coupled to the common electrode.

### CROSS-REFERENCE TO RELATED APPLICATION

This application claims priority to and the benefit of Korean Patent Application No. 10-2010-0104038 filed in the Korean Intellectual Property Office on Oct. 25 2010, the entire content of which is incorporated herein by reference.

### BACKGROUND

1. Field

The described technology relates generally to a display device. More particularly, the described technology relates generally to a display device having a display area and a non-display area.

2. Description of Related Art

A display device is a device for displaying an image.

Lately, a flat panel display such as a plasma display panel (PDP), an organic light emitting diode (OLED) display, or a liquid crystal display (LCD), is widely used.

The liquid crystal display (LCD) includes a first substrate where a pixel electrode is formed, a second substrate where a common electrode is formed, and a liquid crystal layer disposed between the first substrate and the second substrate.

A typical liquid crystal display (LCD) is divided into a display area for displaying an image and a non-display area around the display area. A gate line and a data line are formed to transfer a signal to a pixel electrode at an area (e.g., a predetermined area) corresponding to the display area on the first substrate. The gate line crosses the data line and is insulated from the data line. On the first substrate, a gate fan-out line and a data fan-out line are formed at an area (e.g., a predetermined area) corresponding to the non-display area. The gate fan-out line and the data fan-out line are extended from the gate line and the data line, respectively, and each receive a driving signal from a driver such as an IC.

In addition, a power supply line is formed at a corresponding area of the non-display area on the first substrate of the typical liquid crystal display (LCD). The power supply line is coupled to a common electrode by a conductive spacer and receives common power from the driver in order to supply the common power to the common electrode formed on the second substrate. The common power supply line is formed at the same layer of the gate line or the data line.

However, a common power supply line is formed at the same layer of a gate line for the convenience of design in a typical liquid crystal display (LCD). Particularly, the common power supply line is formed at an outer side of a gate fan-out line in order to prevent the common power supply line from being shorted with the gate fan-out line. Accordingly, the non-display area of the LCD is disadvantageously increased. Such enlargement of the non-display area increases the overall size of a liquid crystal display (LCD).

The above information disclosed in this Background section is only for enhancement of understanding of the background of the described technology, and therefore it may contain information that does not form the prior art that is already known in this country to a person of ordinary skill in the art.

### SUMMARY

The described technology is directed toward a display device having a slim size by minimizing or reducing a non-display area.

An exemplary embodiment provides a display device including a first substrate divided into a display area and a non-display area, a gate line insulated from a data line and crossing the data line in the display area on the first substrate, a second substrate facing the first substrate, a common electrode on the second substrate, a common power supply line at a same layer as the gate line in the non-display area on the first substrate and extending in parallel to the data line, and a short circuit point extending in a direction toward an edge of the first substrate from the common power supply line and being electrically coupled to the common electrode.

The common power supply line and the short circuit point may be integrally formed.

The display device may further include a seal unit along an edge of the second substrate. The common power supply line may be between the seal unit and the display area.

The short circuit point may be between the seal unit and the common power supply line.

The display device may further include a conductive spacer between the short circuit point and the common electrode for coupling the short circuit point with the common electrode.

The display device may further include a fan-out line in the non-display area separated from the gate line with the common power supply line interleaved therebetween and a connecting unit insulated from the common power supply line and crossing the common power supply line, the connecting unit coupling the gate line with the fan-out line.

The connecting unit may be formed at the same layer as the data line.

The display device may further include a gate electrode extending from the gate line, a source electrode extending in a direction toward the gate electrode from the data line, a drain electrode separated from the source electrode, and a pixel electrode coupled to the drain electrode.

The display device may further include a storage line extending from the common power supply line and being overlapped at least partially with the pixel electrode.

The common power supply line and the storage line may be integrally formed.

The gate line may include a plurality of gate lines. The display device may further include a first fan-out line in the non-display area separated from a first gate line among the plurality of gate lines with the common power supply line interleaved therebetween, a connecting unit insulated from the common power supply line and crossing the common power supply line, the connecting unit coupling the first gate line with the first fan-out line, and a second fan-out line insulated from the common power supply line and crossing the common power supply line, the second fan-out line being coupled to a second gate line neighboring with the first gate line among the plurality of gate lines.

The connecting unit and the second fan-out line may be formed at the same layer of the data line.

As described above, the exemplary embodiments provide a display device having a slim size by minimizing or reducing a non-display area.

### BRIEF DESCRIPTION OF THE DRAWINGS

FIG. 1 is a top plan view for illustrating a display device according to a first exemplary embodiment.

FIG. 2 is an enlarged view of section A of FIG. 1.

FIG. 3 is a cross-sectional view of FIG. 2 along a line

FIG. 4 is a top plan view for illustrating a display device according to a second exemplary embodiment.

FIG. 5 is a cross-sectional view of FIG. 4 along a line V-V.

### DETAILED DESCRIPTION OF THE EMBODIMENTS

Hereinafter, the present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

To clearly explain embodiments of the present invention, the portions having no connection to the explanation are omitted, and the same or similar constituent elements are designated by the same reference numerals throughout the specification.

Also, the first exemplary embodiment will be representatively described using like reference numerals for like constituent elements having substantially the same structure in various exemplary embodiments. Other exemplary embodiments will be described based on differences from the first exemplary embodiment.

In the drawings, a size and a thickness of each element is approximately shown for better understanding and ease of description. Therefore, the present invention is not limited to the drawings.

In the drawings, the thicknesses of layers, films, panels, regions, etc., are exaggerated for clarity. In the drawings, the thicknesses of layers or regions may be exaggerated for better understanding and ease of description. It will be understood that when an element such as a layer, film, region, or substrate is referred to as being “on” another element, it can be directly on the other element or intervening elements may also be present.

Also, unless explicitly described to the contrary, the word “comprise” and variations such as “comprises” or “comprising,” will be understood to imply the inclusion of stated elements but not the exclusion of any other elements. It will be understood that when an element is referred to as being “on” another element, it can be above another element or below another element. It does not mean that the element must be above another element in a gravity direction as reference.

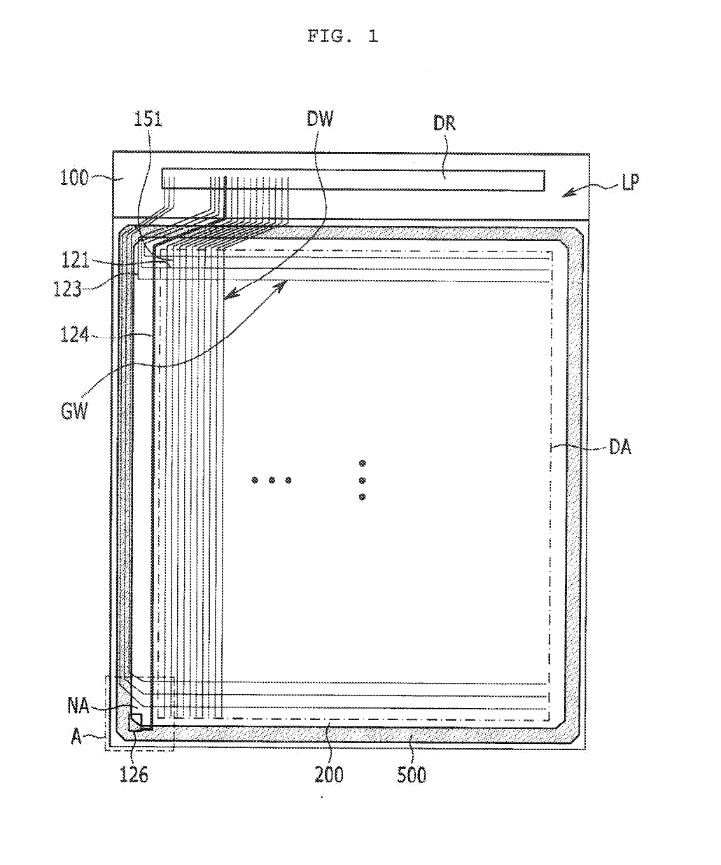

Hereinafter, a display device 1000 will be described according to the first exemplary embodiment in reference with FIG. 1 to FIG. 3.

FIG. 1 is a top plan view illustrating a display device according to the first exemplary embodiment.

As shown in FIG. 1, the display device 1000 is a liquid crystal display (LCD) and includes a liquid crystal panel (LP), a driver (DR), a data driver (DD), and a gate driver (GD).

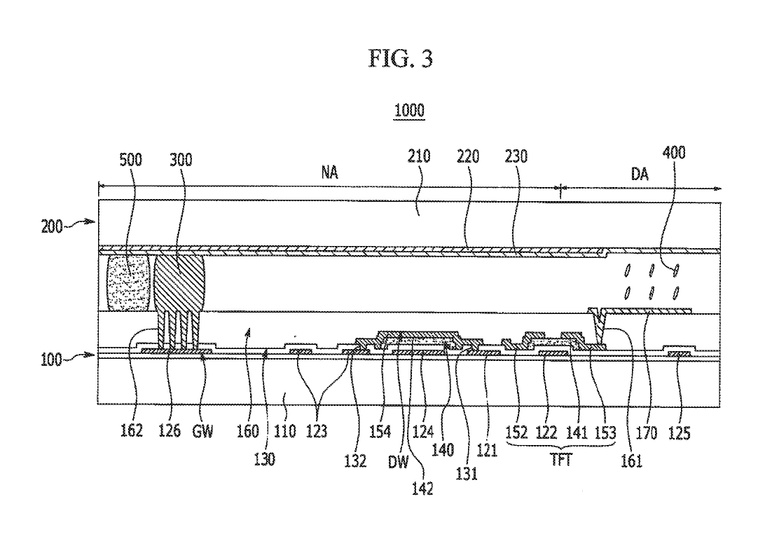

The liquid crystal panel (LP) is divided into a display area (DA) for displaying an image and a non-display area (NA) around the display area (DA). The liquid crystal panel (LP) includes an element substrate 100 having gate wires (GW) and data wires (DW) formed thereon, a common substrate 200 having a common electrode (230, shown in FIG. 3), a liquid crystal layer (400, shown in FIG. 3) disposed between the element substrate 100 and the common substrate 200, and a seal unit 500 for cohering the element substrate 100 and the common substrate 200 together.

The data driver (DD) supplies a data signal to a data line 151 among the data wires (DW) and concurrently (e.g., simultaneously) supplies a common power to a common power supply line 124 among the gate wires (GW). The data driver (DD) may be coupled to the liquid crystal panel (LP) in a form of a tape carrier package with an IC mounted thereon. Alternatively, the data driver (DD) may be mounted on the element substrate 100. For example, the data driver (DD) may be formed in a form of a tape carrier package and coupled to a printed circuit board (PCB) that generates a data signal and a common power source.

Also, a gate driver (GDR) supplies a gate signal to a gate line 121 among the gate wires (GW). A driver (DR) may be coupled to the liquid crystal panel (LP) in a form of a tape carrier package with an IC mounted thereon. Alternatively, the driver (DR) may be mounted on the element substrate 100. For example, the driver (DR) may be formed in a form of a tape carrier package and coupled to a printed circuit board (PCB) that generates a data signal and a common power source.

In the first exemplary embodiment, the driver (DR) is formed in a form of a chip. The driver transmits a gate signal, a data signal, and a common power to the gate line 121, the data line 151, and the common power supply line 124, respectively. In another exemplary embodiment, a display may include a plurality of drivers. The plurality of drivers may selectively transmit at least one of signals among a gate signal, a data signal, and a common power to at least one of a gate line, a data line, and a common power supply line.

The gate driver (GD) may be coupled to the liquid crystal panel (LP) in a form of a tape carrier package with an IC mounted thereon. Alternatively, the gate driver (GD) may be mounted on the element substrate 100. For example, the gate driver (GD) may be mounted on the element substrate 100 and generates a gate signal by using a clock signal, a clock-bar signal and a gate off voltage.

Hereinafter, the liquid crystal panel (LP) will be described in more detail with reference to FIG. 1 to FIG. 3. Hereinafter, a gate fan-out line will be representatively described as an example of a fan-out line.

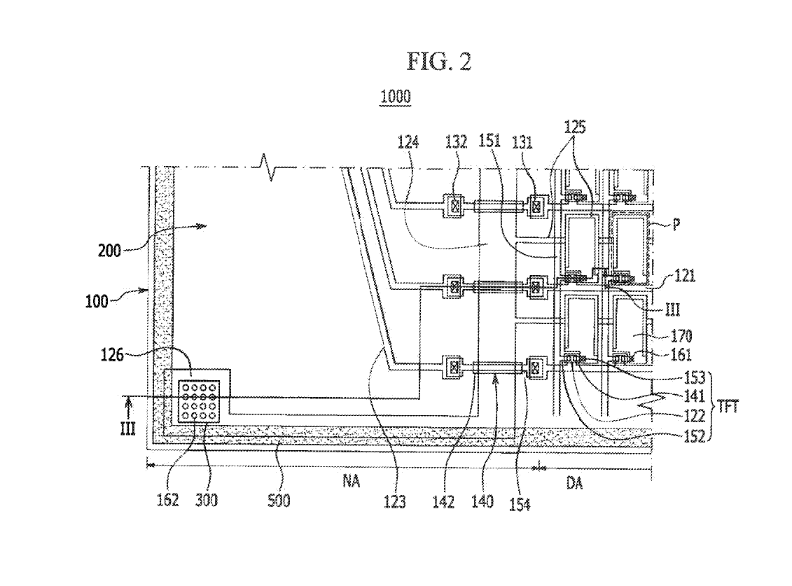

FIG. 2 is an enlarged view of section A of FIG. 1. FIG. 3 is a cross-sectional view of FIG. 2 along the line III to III.

In one embodiment, a liquid crystal panel (LP) includes a device substrate 100, a common substrate 200, a conductive spacer 300, a liquid crystal layer 400, and a seal unit 500.

The device substrate 100 includes a first substrate 110, a gate wire (GW), a first insulation layer 130, an active layer 140, a data wire (DW), a second insulation layer 160, and a pixel electrode 170.

The first substrate 110 is divided into a display area (DA) and a non-display area (NA). The first substrate 110 is formed as a transparent substrate such as glass or plastic. The gate wire (GW), the data wire (DW), and the pixel electrode 170 are formed on the first substrate 110.

The gate wire (GW) may include one or more of aluminum-like metal such as aluminum (Al) and aluminum alloy, silver-like metal such as silver (Ag) and silver alloy, copper-like metal such as copper (Cu) and copper alloy, molybdenum-like metal such as molybdenum (Mo) and molybdenum alloy, chromium (Cr), titanium (Ti), tantalum (Ta), and other suitable metals. Also, the gate wire (GW) may have a multilayer structure including two or more conductive layers (not shown) different in physical properties. The gate wire (GW) includes a gate line 121 formed at the same layer, a gate electrode 122, a gate fan-out line 123, a common power supply line 124, a storage line 125, and a short circuit part (e.g., a short circuit point).

The gate line 121 is disposed corresponding to the display area (DA) and is extended in the row direction. The extended gate line 121 is insulated from the data line 151, which is described in more detail later, and crosses the data line 151. The gate line 121 and the data line 151 may define a pixel (P), which is a minimum unit of a displayed image.

The gate electrode 122 is disposed corresponding to the display area (DA) and protrudes into the area where a pixel (P) is formed from the gate line 121. The gate electrode 122 forms a thin film transistor (TFT) with a source electrode 152, a first semiconductor layer 141, and a drain electrode 153 to be described in more detail later.

The gate fan-out line 123 is disposed corresponding to the non-display area (NA) and is separated from the gate line 121 with the common power supply line 124 interleaved therebetween. The gate fan-out line 123 is coupled to the gate driver (GDR) and transfers a gate signal supplied from the gate driver (GDR) to the gate line 121.

The common power supply line 124 is disposed between the gate line 121 and the gate fan-out line 123 corresponding to the non-display area (NA) between the display area (DA) and the seal unit 500. The common power supply line 124 is extended in parallel to the data line 151 and transmits a common power from the data driver (DD) to the storage line 125 and a short circuit point 126. The width of the common power supply line 124 may be wider than that of the gate line 121 and the data line 151 in order to deliver the common power to the storage line 125 and the short circuit point 126.

The storage line 125 is integrally formed with the common power supply line 124. As the storage line 125 is extended into the area where a pixel (P) is formed from the common power supply line 124, at least one storage line 125 is overlapped with a pixel electrode 170. Here, the pixel electrode 170 will be described in more detail later. Since the storage line 125 is overlapped with the pixel electrode 170, the storage line 125 forms a storage capacitor with the pixel electrode 170. In one embodiment, the storage line 125 is formed along the peripheral area of the pixel electrode 170. However, the storage line 125 is not limited thereto. The storage line 125 may be formed to cross the central part of the pixel electrode 170.

The short circuit point 126 is integrally formed with the common power supply line 124. The short circuit point 126 is extended in a direction toward an edge of the first substrate 110 from the common power supply line 124 and electrically coupled to a common electrode 230 by a conductive spacer 300 that will be described in more detail later. The short circuit point 126 is disposed between the common power supply line 124 and the seal unit 500.

As described above, the storage line 125 and the short circuit point 126 are integrally formed with the common power supply line 124 that is supplied with the common power. Since the loss of common power is minimized or reduced when the common power passing through the common power supply line 124 is transmitted to the storage line 125 and the short circuit point 126, an overall display quality of the display device 1000 is improved.

A first insulation layer 130 is disposed on the above-described gate wire (GW).

The first insulation layer 130 includes at least one of silicon nitride (SiNx) and silicon oxide (SiOx), and a first connecting contact hole 131, and a second connecting contact hole 132. The first connecting contact hole 131 and the second connecting contact hole 132 expose one end of the gate line 121 and the gate fan-out line 123, respectively. The first insulation layer 130 insulates the gate wire (GW) and the active layer 140 from each other. Further, the first insulation layer 130 insulates the gate wire (GW) and the data wire (DW) from each other.

The active layer 140 includes a first semiconductor layer 141 and a second semiconductor layer 142 including hydrogenated amorphous silicon or polysilicon, etc. The first semiconductor layer 141 is disposed in a form of an island corresponding to a gate electrode 122 in a pixel (P), thereby forming a thin film transistor (TFT). The second semiconductor layer 142 is disposed in a form of an island between a connecting unit 154 and the common power supply line 124 corresponding to the common power supply line 124.

The data wire (DW) is disposed on the active layer 140 and the first insulation layer 130.

The data wire (DW) includes a refractory metal such as chromium, and metal such as molybdenum, tantalum, titanium, etc. The data wire (DW) may have a multilayer structure including a substructure layer (not shown) such as a refractory metal, a superstructure layer (not shown) with a low resistance material disposed on the substructure. The data wire (DW) includes a data line 151, a source electrode 152, a drain electrode 153, and a connecting unit 154 formed at the same layer.

The data line 151 is disposed corresponding to the display area (DA) and extended in the column direction. The extended data line 151 is insulated from the gate line 121 with the first insulation layer 130 interleaved therebetween and crosses the gate line 121. The data line 151 and the gate line 121 may define a pixel (P), a minimum unit that displays an image.

The source electrode 152 is disposed corresponding to the display area (DA) and protrudes from the data line 151 to an area where a pixel (P) is formed. The source electrode 152 is extended in a direction toward the gate electrode 122 from the data line 151 and coupled to one end of the first semiconductor layer 141.

The drain electrode 153 is disposed corresponding to the display area (DA) and separated from the source electrode 152. The drain electrode 153 is separated from the source electrode 152 and coupled to the other end of the first semiconductor layer 141. One end of the drain electrode 153 is coupled to a pixel electrode 170 through a pixel contact hole 161 formed on the second insulation layer 160. The pixel contact hole 161 will be described in more detail later. As described above, the drain electrode 153, the source electrode 152, the gate electrode 122, and the first semiconductor layer 141 may form a thin film transistor (TFT). On and off data signal is transmitted to the pixel electrode 170 through the thin film transistor (TFT).

The connecting unit 154 is insulated from the common power supply line 124 with the first insulation layer 130 and the second semiconductor layer 142 interleaved therebetween, and the connecting unit 154 crosses the common power supply line 124. The connecting unit 154 couples the gate line 121 to the gate fan-out line 123, which are separated from each other. Both ends of the connecting unit 154 are coupled respectively to the gate line 121 and the gate fan-out line 123 through the first connecting contact hole 131 and the second connecting contact hole 132 formed on the first insulation layer 130.

The second insulation layer 160 is disposed on the above-described data wire (DW) and the first insulation layer 130.

The second insulation layer 160 includes inorganic material which includes at least one of silicon nitride and silicon oxide, organic material which has excellent planarization characteristic and photosensitivity, or low dielectric constant insulation material such as a-Si:C:O and a-Si:O:F which is formed by plasma enhanced chemical vapor deposition (PECVD). The second insulating layer 160 has a pixel contact hole 161 and a short circuit contact hole 162. The pixel contact hole 161 exposes the drain electrode 153, and the short circuit contact hole 162 exposes the short circuit point 126 passing through the first insulation layer 130.

The pixel electrode 170 is coupled to the drain electrode 153 through the pixel contact hole 161. The pixel electrode 170 receives a data signal from the drain electrode 153 and forms an electric field with a common electrode 230, thereby tilting liquid crystal molecules included in the liquid crystal layer 400. The pixel electrode 170 includes a transparent conducting material such as indium tin oxide (ITO) and indium zinc oxide (IZO).

A common substrate 200 is disposed on the element substrate 100.

The common substrate 200 includes a second substrate 210, a light shielding unit 220, and the common electrode 230.

The second substrate 210 is divided into a display area (DA) and a non-display area (NA) corresponding to the first substrate 110. The second substrate 210 is made of a transparent substrate such as glass or plastic. The light shielding unit 220 and the common electrode 230 are formed on the second substrate 210.

The light shielding unit 220 is disposed corresponding to the non-display area (NA), and includes light shielding material such as chromium (Cr). The light shielding unit 220 prevents constituent elements in the non-display area (NA) from being visible from outside. The common electrode 230 is disposed on the light shielding unit 220.

The common electrode 230 includes a transparent conducting material such as indium tin oxide (ITO) and indium zinc oxide (IZO). The common electrode 230 is formed throughout the second substrate 210. The common electrode 230 receives the common power from the power supply line 124 via the conductive spacer 300 and forms an electric field with the pixel electrode 170, thereby tilting liquid crystal molecules included in the liquid crystal layer 400.

The conductive spacer 300 is disposed between the short circuit point 126 and the common electrode 230, corresponding to a non-display area (NA). The conductive spacer 300 is coupled to the short circuit point 126 through the short circuit contact hole 162 formed at the second insulation layer 160 and coupled between the short circuit point 126 and the common electrode 230. The conductive spacer 300 includes a conductive material such as silver (Ag).

The liquid crystal layer 400 is disposed between the common substrate 200 and the element substrate 100. The seal unit 500 is disposed along the edge of the second substrate 210. The seal unit 500 couples and seals the common substrate 200 with the element substrate 100.

As described above, in the display device 1000 according to the first exemplary embodiment, since the common power supply line 124 is extended in parallel to the data line 151 in the non-display area (NA) between the display area (DA) and the seal unit 500 and disposed between the gate line 121 and the gate fan-out line 123, the size of the non-display area (NA) may be minimized or reduced as compared with the case that the common power supply line 124 is disposed between the edge of the gate fan-out line 123 and the first substrate 110. Although the common power supply line 124 is formed at the same layer of the gate line 121, the display device 1000 has a slim size because the power supply line 124 is formed inside the gate fan-out line 123 and the non-display area (NA) is minimized or reduced.

In the display device 1000 according to the first exemplary embodiment as described above, the storage line 125 and the short circuit point 126 are integrally formed with the common power supply line 124 supplied with a common power. Since the loss of common power is minimized when the common power passing through the common power supply line 124 is transmitted to the storage line 125 and the short circuit point 126, an overall display quality of the display device 1000 is improved. In one embodiment, in a case of forming the storage line 125, the short circuit point 126, and the common power supply line 124 with aluminum and aluminum alloy that are low in electrical resistance compared with a data wire (DW), the loss of common power is further minimized or reduced when the common power passing through the common power supply line 124 is transmitted to the storage line 125 and the short circuit point 126. Accordingly, an overall display quality of the display device 1000 is further improved.

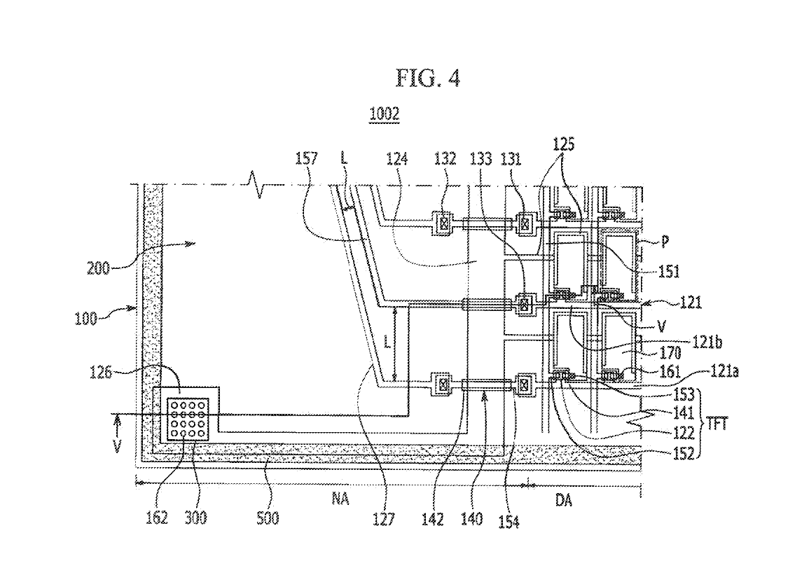

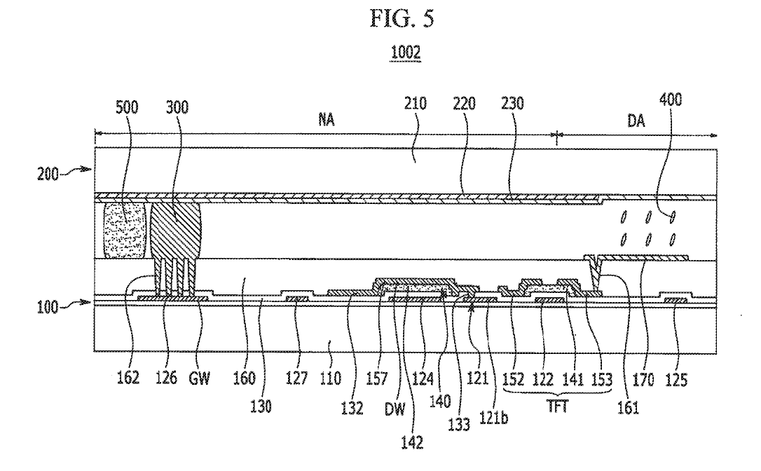

Hereinafter, a display device 1002 will be described according to the second exemplary embodiment with reference to FIG. 4 and FIG. 5.

FIG. 4 is a top plan view for illustrating a display device according to the second exemplary embodiment. FIG. 5 is a cross-sectional view along the line V-V in accordance with FIG. 4.

As shown in FIG. 4 and FIG. 5, the display device 1002 includes a first fan out-line 127 and a second fan-out line 157 according to the second exemplary embodiment.

The first fan-out line 127 is disposed in a non-display area (NA). The first fan-out line 127 is separated from a gate line 121a among a plurality of the gate lines 121 with the common power supply line 124 interleaved therebetween. The first fan-out line 127 is coupled to a connecting unit 154 through the second connecting contact hole 132 of the first insulation layer 130. The connecting unit 154 is coupled to the gate line 121a through the first connecting contact hole 131 of the first insulation layer 130. The first fan-out line 127 is formed at the same layer as a gate wire (GW).

The second fan-out line 157 is disposed in the non-display area (NA). The second fan-out line 157 is insulated from the common power supply line 124 and crosses the common power supply line 124 with the first insulation layer 130 interleaved therebetween. The second fan-out line 157 is coupled with another gate line 121b neighboring with the gate line 121a among the plurality of gate lines 121 through the third connecting contact hole 133 at the first insulation layer 130. The second fan-out line 157 is formed at the same layer as a data wire (DW) including the data line 151 and is different from the layer of the first fan-out line 127. In other words, the second fan-out line 157 is separated from the first fan-out line 127 with the first insulation layer 130 interleaved therebetween, and the first fan-out line 127 and the second fan-out line 157 are disposed at different layers. As a result, although a length (L) between the first fan-out line 127 and the second fan-line 157 is narrowly formed, a short circuit between the first fan-line 127 and the second fan-out line 157 is prevented.

Since the first fan-out line 127 is formed with a narrow distance L from the neighboring second fan-out line 157 by being coupled to corresponding neighboring gate lines 121 in the display device 1002 according to the second exemplary embodiment, the non-display area (NA) can be further reduced.

As described above, the common power supply line 124 is disposed between the gate line 121a and the first fan-out line 127, and between the gate line 121b and the second fan-out line 157 in the display device 1002 according to the second exemplary embodiment. In addition, a length (L) between the first fan-out line 127 and the neighboring second fan-out line 157 is formed to be narrow. Accordingly, the non-display area (NA) is minimized or reduced. Since the non-display area (NA) of the display device 1002 is minimized or reduced, although the common power supply line 124 is formed at the same layer of the gate line 121 and a length (L) between the first fan-out line 127 and the second fan-out line 157 is formed to be narrow, the display device 1002 may be manufactured to have a slim size.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A display device comprising:
a first substrate divided into a display area and a non-display area;
a gate line insulated from a data line and crossing the data line in the display area on the first substrate;
a second substrate facing the first substrate;
a common electrode on the second substrate;
a common power supply line at a same layer as the gate line in the non-display area on the first substrate and extending in parallel to the data line; and
a short circuit point extending in a direction toward an edge of the first substrate from the common power supply line and being electrically coupled to the common electrode.

2. The display device of claim 1, wherein the common power supply line and the short circuit point are integrally formed.

3. The display device of claim 1, further comprising a seal unit along an edge of the second substrate,
wherein the common power supply line is between the seal unit and the display area.

4. The display device of claim 3, wherein the short circuit point is between the seal unit and the common power supply line.

5. The display device of claim 4, further comprising:
a conductive spacer between the short circuit point and the common electrode for coupling the short circuit point with the common electrode.

6. The display device of claim 1, further comprising:
a fan-out line in the non-display area and being separated from the gate line with the common power supply line interleaved therebetween; and
a connecting unit insulated from the common power supply line and crossing the common power supply line, the connecting unit coupling the gate line with the fan-out line.

7. The display device of claim 6, wherein the connecting unit is formed at a same layer as the data line.

8. The display device of claim 6, further comprising:
a gate electrode extending from the gate line;
a source electrode extending in a direction toward the gate electrode from the data line;
a drain electrode separated from the source electrode; and
a pixel electrode coupled to the drain electrode.

9. The display device of claim 8, further comprising:
a storage line extending from the common power supply line and being at least partially overlapped with the pixel electrode.

10. The display device of claim 9, wherein the common power supply line and the storage line are integrally formed.

11. The display device of claim 1, wherein the gate line comprises a plurality of gate lines which are neighbors to each other, and
the display device further comprises:
a first fan-out line in the non-display area and being separated from a first gate line among the plurality of gate lines with the common power supply line interleaved therebetween;
a connecting unit insulated from the common power supply line and crossing the common power supply line, the connecting unit coupling the first gate line with the first fan-out line; and
a second fan-out line insulated from the common power supply line and crossing the common power supply line, the second fan-out line being coupled to a second gate line neighboring with the first gate line among the plurality of gate lines.

12. The display device of claim 11, wherein the connecting unit and the second fan-out line are formed at a same layer of the data line.
